(19) United States
(12) Patent Application Publication
(10) Pub. No.: US 2009/0292590 A1
(43) Pub. Date: Nov. 26, 2009

(54) METHOD FOR EVALUATING AN EMPLOYEE

(76) Inventor: ADEEL ZAIDI, Houston, TX (US)

Correspondence Address: BUSKOP LAW GROUP, P.C., 4511 Dacoma Street, HOUSTON, TX, 77092, US

(21) Appl. No.: 12/471,323

(22) Filed: May 22, 2009

Related U.S. Application Data
(60) Provisional application No. 61/055,613, filed on May 23, 2008.

(51) Int. Cl. G06Q 99/00; G06F 17/30

(52) U.S. Cl. 705/10; 707/104.1; 707/9; 705/11; 707/1; 707/E17.005; 707/E17.001; 707/E17.044; 726/5

(57) ABSTRACT

A method for evaluating an employee. The method for evaluating an employee can include the steps of communicating with a processor. The processor can be in communication with a database. The database can have at least one fillable employee evaluation template with at least eight non-industry specific categories. The method can also include creating at least one department using a client device in communication with the processor and storing the at least one department in the database.

### CROSS REFERENCE TO RELATED APPLICATION

The present application claims priority and benefit to U.S. Provisional Patent Application Ser. No. 61/055,613 filed on May 23, 2008, entitled “Method for Evaluating an Employee”. This reference is incorporated in its entirety.

### FIELD

The present embodiments relate to a method for performing employee evaluations.

### BACKGROUND

A need exists for an efficient accurate employee evaluation method for performing an objective evaluation of an employee.

A further need exists for an employee evaluation method that allows for accurate real time tracking of an employee's performance.

The present embodiments meet these needs.

### BRIEF DESCRIPTION OF THE DRAWINGS

FIG. 1 depicts an embodiment of the system for employee evaluations.

FIG. 2 depicts an embodiment of a screen shot for creating at least one department.

FIG. 3 depicts an embodiment of a screen shot for creating at least one supervisor profile and associating the supervisor profile with a department.

FIG. 4 depicts an embodiment of a screen shot for creating an employee profile and associating the employee profile with a department.

FIG. 5 depicts an embodiment of a screen shot for performing an evaluation of an employee.

FIG. 6 depicts an embodiment of a screen shot for viewing a percentage of all employee profiles placed within each of the five rating categories.

FIG. 7 depicts an embodiment of a flow diagram for an evaluation of an employee.

FIG. 8 depicts a flow diagram for creating an employee completed employee evaluation.

The present embodiments are detailed below with reference to the listed Figures.

### DETAILED DESCRIPTION OF THE EMBODIMENTS

Before explaining the present method in detail, it is to be understood that the method is not limited to the particular embodiments and that it can be practiced or carried out in various ways.

A portion of the disclosure of this patent document contains material which is subject to copyright and/or mask work protection. The copyright and/or mask work owner has no objection to the reproduction by anyone of the patent document as it appears in the Patent and Trademark Office patent file or records, but otherwise reserves all copyright and/or mask work rights.

The present embodiments relate to a method for performing employee evaluations.

An embodiment of the method can include communicating with a processor, which can be in communication with a database, and creating at least one department using a client device, which can be communication with the processor. An embodiment of the method can also include the step of creating at least one supervisor profile and storing the supervisor profile in the database.

The database can be encrypted and accessible only by the use of a user ID and password. The database can have a fillable employee evaluation template that can have at least eight non-industry specific categories.

The method can also include the step of creating at least one employee profile and storing the employee profile in the database.

The supervisor profile and the employee profile can each be independently associated with a department.

The method can also include the step of performing an evaluation of a selected employee by the supervisor.

The evaluation can include selecting one of the fillable employee evaluation templates. The evaluation can also include selecting an employee profile associated with the selected employee.

The evaluation can also include clicking on 1 of 5 rating sections for each of the at least eight non-industry specific categories to designate a score for each eight non-industry specific categories. The at least eight non-industry specific categories can include productivity, teamwork, job habits, quality, attendance, flexibility, dependability, and job knowledge. In another embodiment, additional categories can be used and number more than eight.

The 1 of 5 ratings can be associated with five rating categories, such as unsatisfactory, marginal, satisfactory, good, and exceptional. In another embodiment, additional rating categories can be used and number more than five.

During the evaluation, the supervisor can view continually adjusting real time scoring. For example, as the supervisor rates the selected employee on the scale of 1 to 5 for the eight non-industry specific categories, the scoring for the employee will update in real time. If the employee had an average of 2 for all categories in the last two evaluations and the supervisor clicks on the 4 rating for each category, then the composite average score section, also referred to as the year-to-date score, can be updated in real time to display a composite average score of 2.67 for the last three evaluations.

The continually adjusting real time score can include a total score of the selected employee, an average score for all eight different categories and a composite average score for all total scores of the selected employee. The composite average score can be a score for up to twelve months of total scores of the selected employee.

The supervisor can insert his comments into a supervisor comments section forming a supervisor completed employee evaluation, and can save the supervisor completed employee evaluation.

The embodiments of the method can be performed with a system. The system can include at least one processor. The processor can be in communication with a database. The system can have computer instructions requiring a user ID and password to access computer instructions in the database. The database can be encrypted.

The system can have at least one client device for communicating with the processor. The client device can be hard wired to the processor or can be in wireless communication with the processor.

The database can include computer instructions. The computer instructions can include at least one fillable employee evaluation template with at least eight non-industry specific categories.

The system can also include computer instructions for creating at least one department. The creation of the at least one department can be defined as creating a link to a portion of the database named for a specific department, within which data related to supervisors of the at least one department and employees working within the department are stored. For example, a user, which can be a supervisor, a chief executive officer, a human resource officer, or a similar person in the organization, can use the system and the computer instructions to create a database named after a department within the organization, such as a marketing department, engineering department, operations department, or similar common departments in an organization. Employee profiles for each employee within the at least one department can be stored in the database.

The system can also include computer instructions for creating at least one supervisor profile with supervisor information, and for associating the at least one supervisor profile with at least one department. For example the supervisor profile can be created by entering the specific name of a supervisor such as Bill Jones, this name can be linked to a department created by the computer instructions for creating the least one department. Then the supervisor can access employee profiles associated with employees within the department that the supervisor is associated with.

The system can also have computer instructions for creating at least one employee profile and associating the at least one employee profile with the at least one department. For example, if a department has two employees, Tom and Bill, the computer instructions for creating at least one employee profile can be used to create a file within the created department named for each employee. The employee profiles can be associated with the created department allowing an associated supervisor to access Tom and Bill's profiles.

When the employee profiles are created, the system can have computer instructions allowing a photo of the employee to be associated with the created employee profile.

The system can be adapted to only allow the supervisor to view the employee profiles associated with the supervisor's department.

In an embodiment of the system, the supervisor can report directly to a manager, and the manager can have access to the department information of all of the supervisors directly reporting to the manager. The manager can report to a division manager, and the division manager can have access to the department information of all of the supervisors reporting to the manager. A chief operating officer, a chief executive officer, another officer of the business organization, a human resource officer, a legal department personnel, and combinations thereof can have access to the department information of all the departments.

At least one employee profile can be created by uploading employee information from a linked data-source. For example the database can be linked to a master employee record created by a user, such as a human resource officer. The linked record can be in excel format or comma space value (CSV).

The system can also have computer instructions enabling at least one supervisor to perform an evaluation of the employees associated with his department.

The evaluation can include the steps of: selecting one of the fillable employee evaluation templates. Then selecting the employee profile for the employee to be evaluated from the created employee profiles. When the employee profile is selected, any prior employee evaluation records for the selected employee profile can be available to the supervisor performing the evaluation.

Then the supervisor can click on 1 of 5 ratings for each of the at least eight non-industry specific categories to designate the rating as a score. The eight non-industry specific categories can include, but is not limited to, productivity, teamwork, job habits, quality, attendance, flexibility, dependability, and job knowledge. The 1 of 5 ratings can be associated with five rating categories, such as unsatisfactory, marginal, satisfactory, good, and exceptional, but are not limited to these five.

In an embodiment of the system, the at least eight non-industry specific categories can be customized by the chief operating officer, chief executive officer, other officers of the business organization, human resource personnel, legal department personnel, and combinations thereof.

During the evaluation, the supervisor can view continually adjusting real time scoring in a displayed score section.

The continually adjusting real time score can include a total score of the selected employee, an average score for all of the at least eight non-industry specific categories, and a composite average score for all total scores of the selected employee.

Returning to the method, the supervisor can then insert supervisor comments into a supervisor comments section. After this step a supervisor completed employee evaluation can be formed. The supervisor can then save the supervisor completed employee evaluation.

In an embodiment of the method, the employee evaluation can continue by the supervisor e-mailing a notification that the employee's supervisor completed employee evaluation is complete, and that the employee's comments are needed on the supervisor completed employee evaluation. The employee can then go to the supervisor to have his comments inputted to the employee comment section on the supervisor completed employee evaluation, forming an employee completed employee evaluation.

After the employee completed employee evaluation is formed, the employee completed employee evaluation can be printed and the selected employee and the supervisor can sign the printed employee completed employee evaluation.

In an alternative embodiment the supervisor can print out the supervisor completed employee evaluation and give a hard copy to the selected employee and the selected employee can insert his comments onto the hard copy of the supervisor completed employee evaluation. The system can further include computer instructions for emailing the supervisor completed employee evaluation to the employee. The employee can then fill in the supervisor completed employee evaluation and email it back, or deliver the hard copy back to the supervisor. The employee can also give comments to the supervisor and the supervisor can then input the employee comments to the employee comment section of the supervisor completed employee evaluation creating an employee completed employee evaluation.

The system can include a means of controlling a supervisor completed employee evaluation. The means for controlling the supervisor completed employee evaluation can be a master password protecting the selected employee's file. The master password can be an alphanumeric password. The method can then require the master password before a person can edit the supervisor completed employee evaluation. In an embodiment of the system, only the department supervisor can have the master password allowing the department supervisor to edit the supervisor completed employee evaluation after insertion of the master password.

The system can include computer instructions for creating an icon in the programs file of the processor and on a desktop of the at least one client device to access the computer instructions stored in the database.

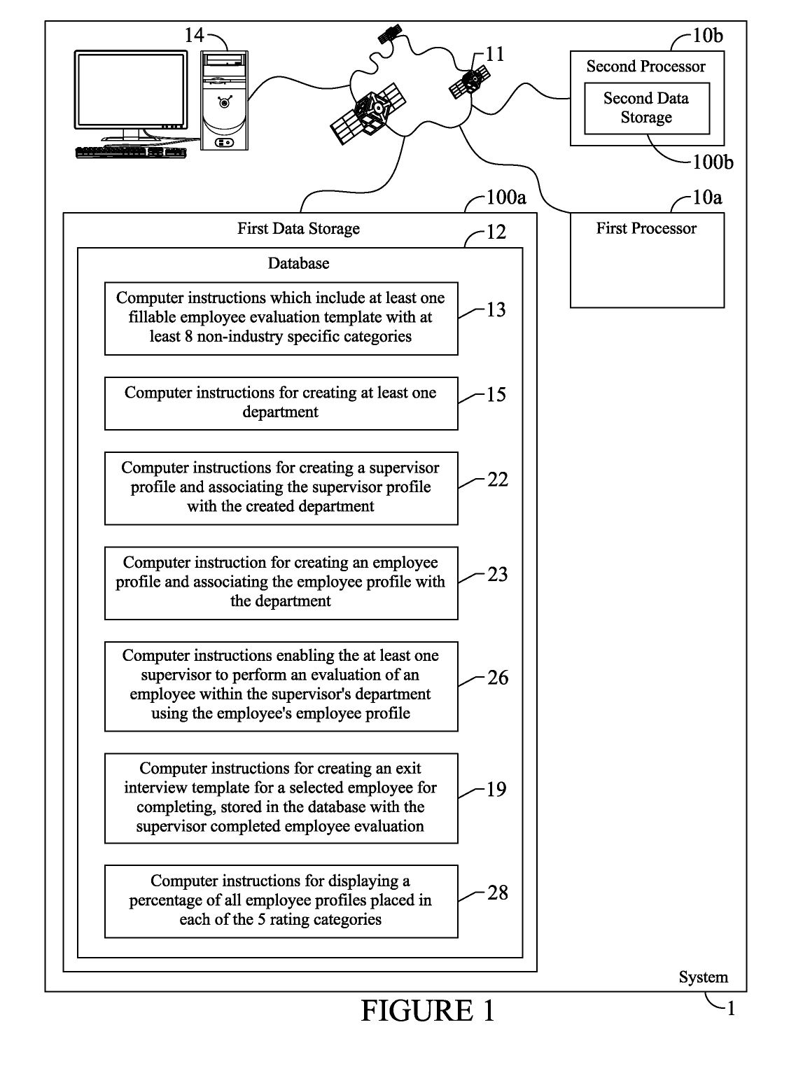

Turning now to the Figures, FIG. 1 depicts an embodiment of the system. The depicted system 1 can have at least one processor 10. For example the at least one processor can be a Pentium™ processor, a customized processor, a personal computer, a laptop, or similar processors commonly known in the art.

The at least one processor 10 can be in communication with a database 12. The database 12 can be integral with the at least one processor 10 or remote from the at least one processor and connected to the at least one processor by a network 11, a flash drive in communication with the processor 10, or similar media used to store data.

At least one client device 14 can be in communication with the at least one processor 10, allowing the supervisor or other user to input information into the database. The at least one client device 14 can be a personal computer with a key board, a laptop, or similar devices used to input information into a processor. The at least one client device 14 can be in communication with the at least one processor 10 by a wireless connection, a wired connection, or a network connection. The at least one client device 14 can also be in communication with the at least one processor 10 through network 11.

The database 12 can include computer instructions 13, which can include at least one fillable employee evaluation template with at least eight non-industry specific categories. There can be more than the eight non-industry specific categories.

The at least eight non-industry specific categories can include productivity, such as how fast the employee completes required work; teamwork, such as how the employee works with other employees to accomplish a job task; job habits, such as attention to detail; quality, such as how well done the employees work product is; attendance, such as tardiness or absences; flexibility, such as how well the employee is able to adjust to different circumstances; dependability, such as if the employee completes their work tasks when needed; and job knowledge, such as how well the employee grasps the use of a mechanical press.

The database can also include computer instructions 15 for creating at least one department. The created department can be an engineering department of an organization, a sales department of an organization, a marketing department, or similar departments that make up a business organization, or combinations of multiple departments. The system can further have computer instructions 22 for creating at least one supervisor profile and associating the at least one supervisor profile with the created at least one department. The supervisor's information can be inputted into the supervisor profile. The supervisor information can include the supervisor's department, the name of the supervisor, the supervisor's hire date, an e-mail address, telephone number or fax number for the supervisor, or similar identification or contact information.

The system can also include computer instructions 23 for creating at least one employee profile and associating the at least one employee profile with at least one department.

The system can also have computer instructions 26 for enabling the at least one supervisor to perform an evaluation of an employee within the supervisor's department using the employee's employee profile.

The system can also have computer instructions 28 for displaying a percentage of all employee profiles placed in each of the five rating categories. The computer instructions 28 can also be used to depict a percentage of all employee profiles within a specific department that have been placed in each of the five rating categories.

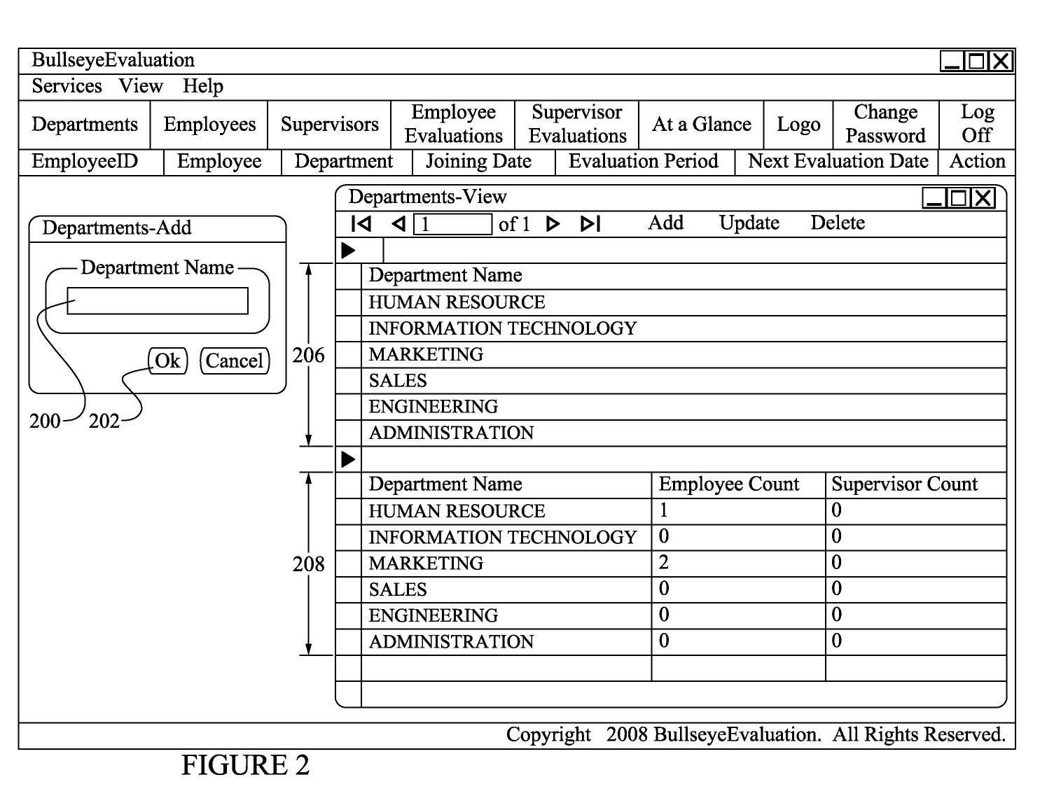

FIG. 2 depicts an embodiment of a screen shot for creating at least one department. The computer instructions for creating at least one department can also display the depicted screen shot, which will allow a supervisor, a human resource personal, or similar officer of an organization to create a department. The supervisor can use the computer instructions for creating the at least one department by inputting the department name into box 200. Then the supervisor can click on the ok button 202. The computer instructions can then create a file within the data storage named after the department.

The department view box 206 can display all the created at least one departments. Department information box 208 can display the number of employee profiles associated with each created at least one department and the number of at least one supervisor profiles associated with each created at least one department.

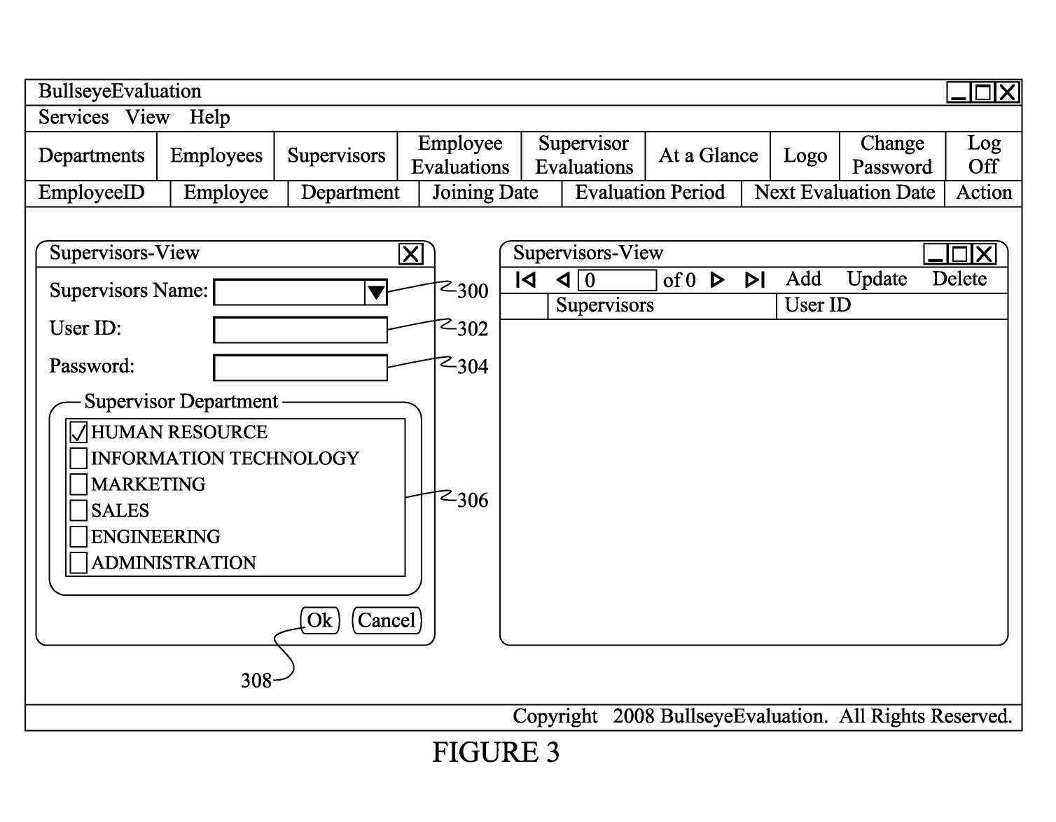

FIG. 3 depicts an embodiment of a screen shot for creating at least one supervisor profile and associating the supervisor profile with at least one department. The screen shot depicted in FIG. 3 can be created by the computer instructions for creating at least one supervisor profile. The supervisor's name can be inputted into the supervisor's name box 300, the name can be inputted by a user, such as the supervisor, a human resource personal, or another officer of the business organization.

A user ID can be inputted into the user ID box 302. The user ID can be a user name, such as “coal12”. A password can then be inputted into the password box 304. The password can be selected by the user, such as the supervisor and can be alphanumeric.

The at least one supervisor profile can then be associated with a specific created department by using the supervisor department check box 306. To complete the creation of the at least one supervisor profile the ok button 308 can then be clicked.

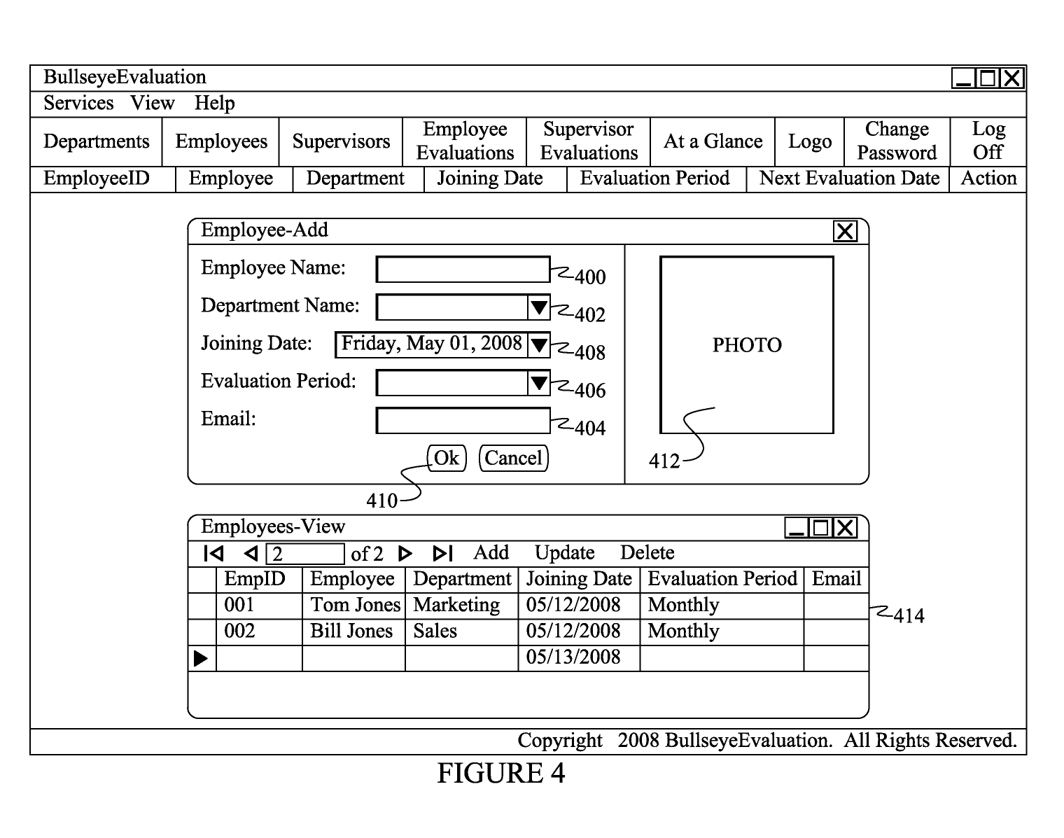

FIG. 4 depicts an embodiment of a screen shot for creating at least one employee profile and associating the at least one employee profile with a department.

The computer instructions for creating the at least one employee profile can include employee name box 400. For example if the department has an employee Bill Jones, and the supervisor wants to create an employee profile for Bill Jones he can enter Bill Jones into employee name box 400.

The at least one employee profile can be associated with a department by inserting the employee's department name in department name box 402. For example if Bill Jones works in the marketing department then marketing can be entered into department name box 402.

In evaluation period box 406 the evaluation period can be selected. For example the evaluation period can be monthly, quarterly, half yearly, and yearly. The joining date for the employee can be entered into the joining date box 408.

A photo of the employee can also be uploaded into the at least one employee profile by the use of photo upload box 412.

The employee e-mail can be entered into the e-mail box 404. After the at least one employee profile is created using the computer instructions for creating the at least one employee profile, the employee can then be associated with the department entered into department name box when the ok button 410 is clicked on.

The computer instructions for creating the at least one employee profile can also display an employee-view box 414 as the at least one employee profile is being created. The employee-view box 414 can display all employee profiles created.

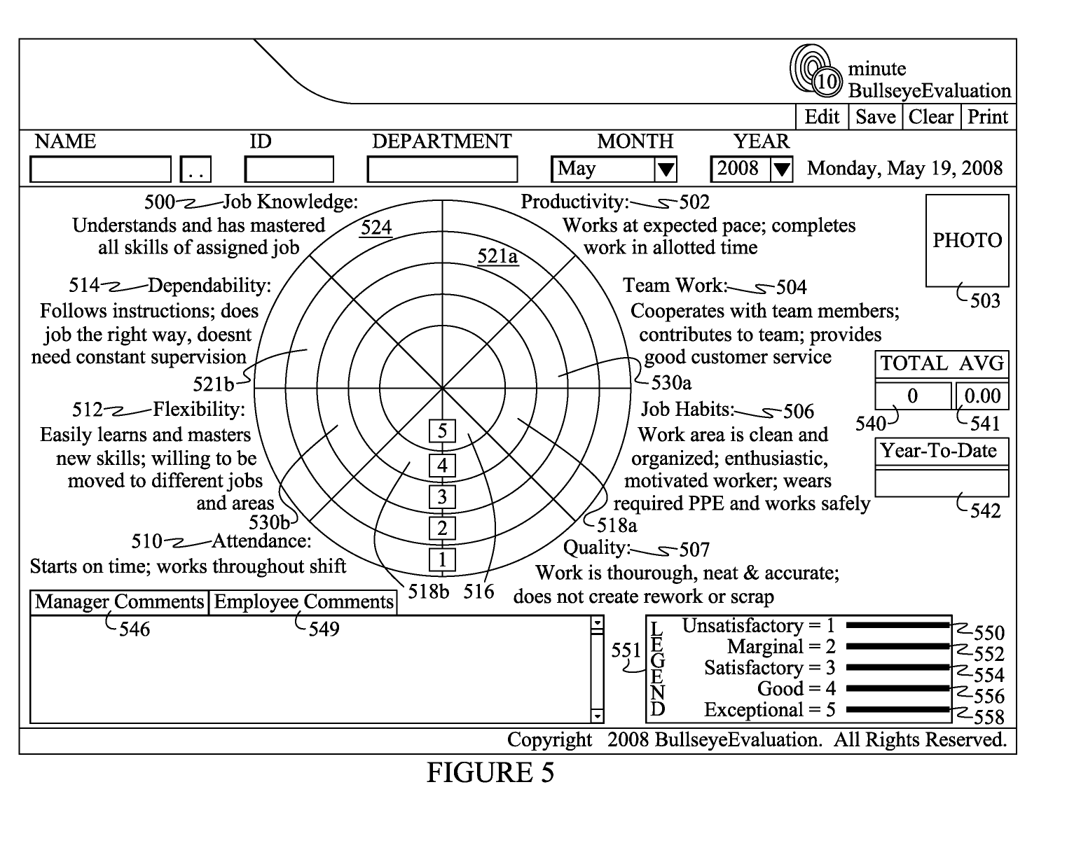

FIG. 5 depicts an embodiment of a screen shot for performing an evaluation of an employee. The employee evaluation template is also depicted in this Figure. The employee template can include at least eight non-industry specific categories.

The Figure depicts a first non-industry specific category 500 as job knowledge. Job knowledge can relate to whether or not the employee understands and has mastered all skills associated with assigned jobs. In the depicted employee evaluation form the supervisor performing the evaluation has classified the selected employee in an unsatisfactory rating category 550 for the first category 500, by clicking on the 1 rating section 524 associated with the first non-industry specific category 500.

The second non-industry specific category 502 shown is productivity, which rates the employee on the employee's work pace and ability to complete work in an allotted time. The selected employee has been placed in a marginal rating category 552 for the second non-industry specific category 502, by the supervisor clicking on the 2 rating section 521a associated with the second non-industry specific category 502.

The third non-industry specific category 504 shown is team work, which rates the employee on his ability to cooperate with team members, how he contributes to the team, and the employee's customer service. The selected employee has been placed in a satisfactory rating category 554 for the third non-industry specific category 504, by the supervisor clicking on the 3 rating section 530a, which is associated with the third non-industry specific category 504.

The fourth non-industry specific category 506 shown rates the employee on his job habits, including if the employee's work area is clean and organized, if the employee wears the required attire, and if the employee works safely. The selected employee has been placed in a good rating category 556 for the fourth non-industry specific category 506, by the supervisor clicking on the 2 rating section 518a, which is associated with the fourth non-industry specific category 506.

The fifth non-industry specific category 507 shown rates the employee on his quality. The fifth non-industry specific category 507 rates whether or not the employee's work is thorough, neat, and accurate. The selected employee has been placed in an exceptional rating category 558 for the fifth non-industry specific category 507, by the supervisor clicking on the 5 rating section 516, which is associated with the fifth category 507.

The sixth non-industry specific category 510 shown is attendance. The sixth category rates the employee on if he starts on time and works throughout the shift. The selected employee has been placed in the good rating category 556 for the sixth non-industry specific category 510, by the supervisor clicking on the 4 rating section 518b, which is associated with the sixth non-industry specific category 510.

The seventh non-industry specific category 512 shown is flexibility. The seventh non-industry specific category rates the employee on how easy he learns and masters new skills, and if he is willing to be moved to different jobs and areas. The selected employee has been placed in the satisfactory rating category for the seventh non-industry specific category 512, by the supervisor clicking on the 3 rating section 530b, which is associated with the seventh non-industry specific category 512.

The eighth non-industry specific category 514 shown is dependability. The eighth non-industry specific category 514 rates the employee on how the employee follows instructions, if the employee correctly performs his job, and how much supervision the employee needs. The selected employee has been placed in the marginal rating category 552 for the eighth non-industry specific category 514, by the supervisor clicking on the 2 rating section 521b, which is associated with the eight non-industry specific category 514.

As the employee is evaluated by the supervisor clicking on the rating section associated with each of the at least eight non-industry specific categories, the total score box 540 displays a real time total score for all at least eight non-industry specific categories for the employee. The score can then be calculated based on the point value assigned with each rating section.

The average score box 541 can display in real time the average score for the evaluated employee. The average score can be calculated by summing each score for each of the at least eight non-industry specific categories and dividing by the number of categories rated. For example if the supervisor has rated the employee on 2 of the at least eight non-industry specific categories and the employee was given a 2 rating for one of the at least eight non-industry specific categories and a 3 rating for the other at least eight non-industry specific categories, then the average score box 541 can display an average score of 2.5.

The year-to-date score box 542 can give the composite average for a twelve month period of evaluations.

A photo of the selected employee can be displayed in the photo box 503.

The legend box 551 can explain the relationship between the rating and the rating category. Each rating category can be associated with a color code. For example the rating 1 can be associated with the unsatisfactory rating category, and the color green can indicate when an employee has been rated a 1 for a non-industry specific category.

The supervisor can then enter his comments in the supervisor's comments section 546. After the supervisor enters his comments a supervisor completed employee evaluation can be completed.

The supervisor can then have the employee enter his comments into the employee comment section 549 at the same time, or the supervisor can print out or email the supervisor completed employee evaluation and give it to the employee for the employee to enter the employee comments into the employee comment section 549.

The supervisor can then input the hand written employee's comments into the employee comment box on the supervisor completed employee evaluation and form an employee completed employee evaluation.

The supervisor completed employee evaluation can then be saved. Further, the employee completed employee evaluation can also be saved.

The supervisor can authenticate the employee completed employee evaluation by inserting his signature manually on a printed employee completed employee evaluation. The employee can authenticate the employee completed employee evaluation by inserting his signature on the printed employee completed employee evaluation.

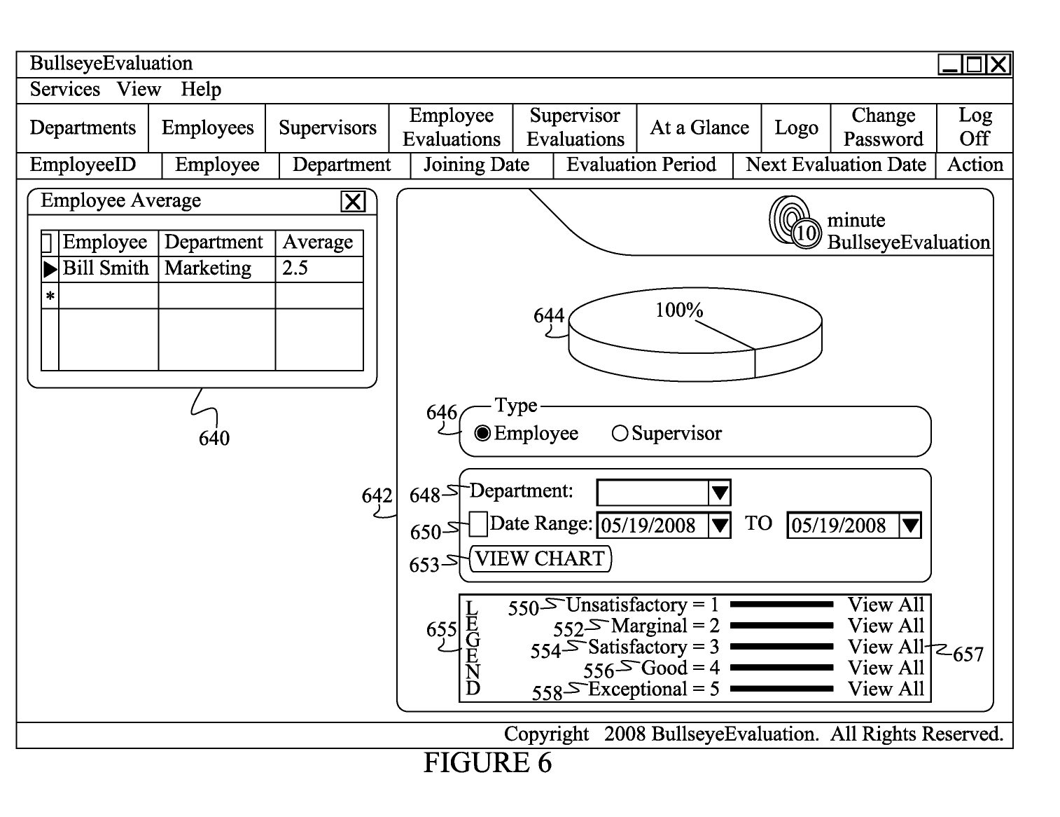

FIG. 6 is an embodiment of a screen shot created by the computer instructions for generating a percentage of all employee profiles placed in each of the five rating categories. The employee average box 640 can display a list of employee profiles, the departments the employee profiles are associated with, and their composite average rating.

The representation box 642 can display a chart 644, which can represent the percentage of employee profiles placed in each of the five rating categories. The chart can be a pie chart, a bar chart, or a similar graphical chart. The representation box 642 has a type selection box 646, where the user can select to view the percentage of supervisor profiles within each of the five rating categories or the percentage of employees within each of the five rating categories.

The user can then use the department drop down box 648 to select all employee profiles or all employee profiles associated with a specific department. The user can then use the date range drop down box 650 to select a time period. For example if the user wants to see the percentage of employee profiles within each of the 5 rating categories for the time period starting on May 5, 2005 and ending Jun. 5, 2005 the employee can select the appropriate date range from the date range drop down box 650.

After the user has selected the type, the department, and the date range, they can then click on the view chart box 653 and the computer instructions can generate the appropriate chart.

The representation box 642 can also include a legend box 655. The legend box can identify each of the five rating categories and can display the percentage of employee profiles within each of the five rating categories. The user can click a view all link 657 and it can display a list of all employee profiles within the associated rating category.

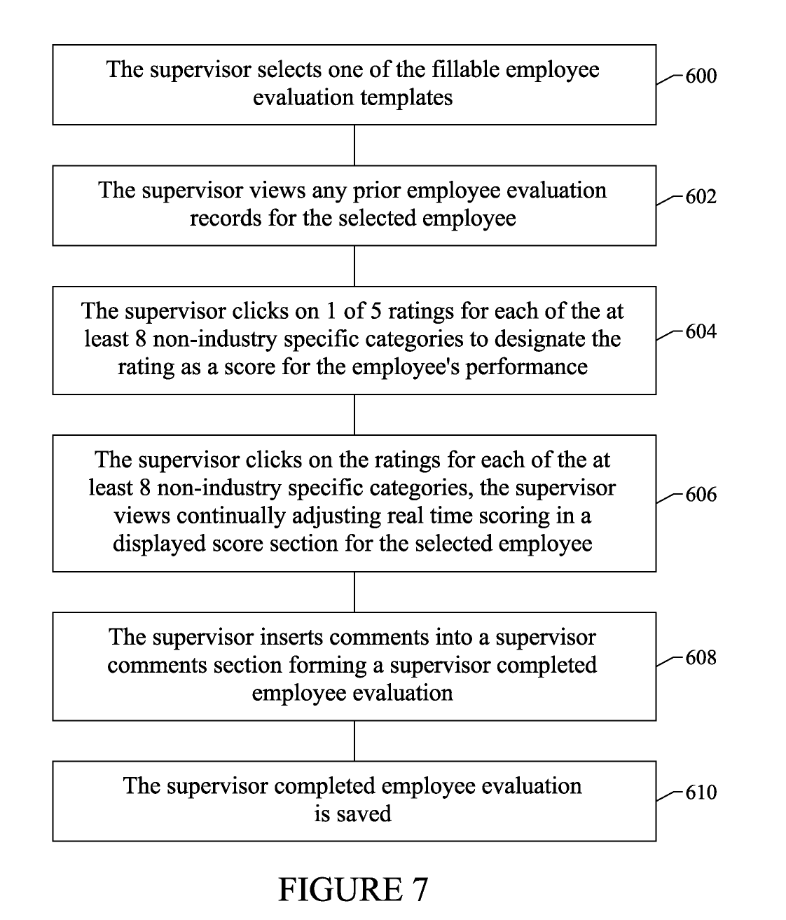

FIG. 7 depicts a flow diagram for the embodiments of performing an employee evaluation. In step 600, the supervisor selects one of the fillable employee evaluation templates. In step 602 the supervisor views any prior employee evaluation records for the selected employee.

In step 604, the supervisor clicks on 1 of 5 ratings for each of the at least eight non-industry specific categories to designate the rating as a score for the employee's performance. The rating scale starts at 1 and ends at 5. 5 is the highest score.

In step 606, as the supervisor clicks on the ratings for each of the at least eight non-industry specific categories, the supervisor views continually adjusting real time scoring in a displayed score section for the selected employee.

In step 608, the supervisor inserts comments into a supervisor comments section forming a supervisor completed employee evaluation. The supervisor comments can include “the employee has dedication to the company.” After the supervisor enters the supervisor comments a supervisor completed employee evaluation is created. Then in step 610 the supervisor completed employee evaluation is saved.

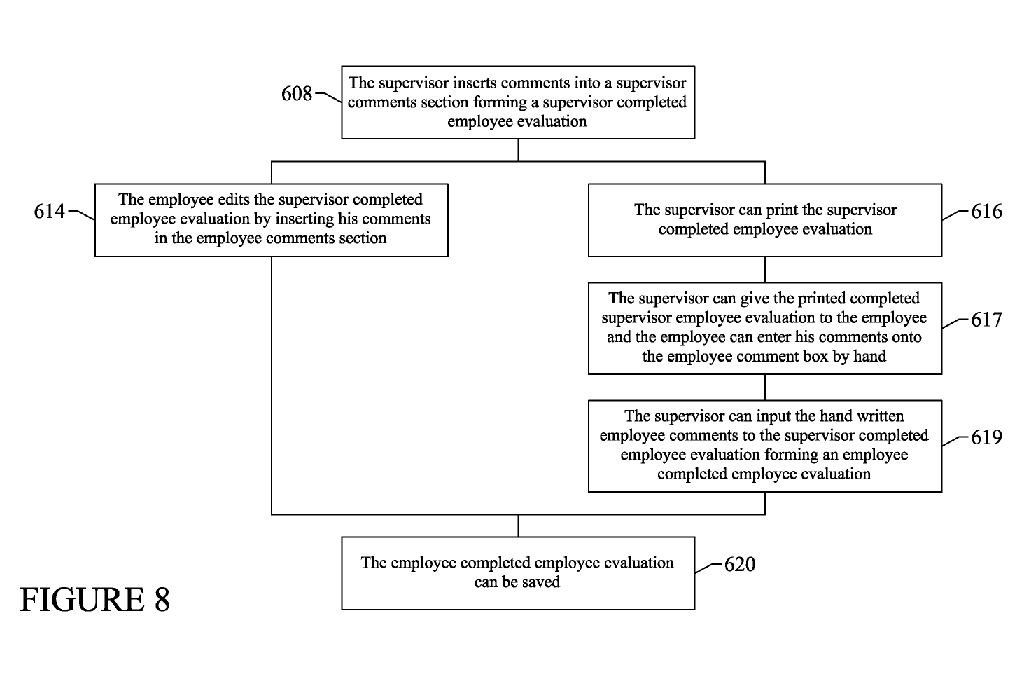

FIG. 8 depicts an embodiment of the method for creating an employee completed employee evaluation. The method can start at step 608, as previously described in FIG. 6. In step 614 the employee can edit the supervisor completed employee evaluation by inserting his comments in the employee comments section. The employee comments can be “I would like more training on the press operation.” Then in step 620 the employee completed employee evaluation can be saved.

Instead of step 614, the supervisor can print the supervisor completed employee evaluation in step 616. Then in step 617 the supervisor can give the printed supervisor completed employee evaluation to the employee and the employee can enter his comments onto the employee comment box by hand. Then in step 619 the supervisor can input the hand written employee comments to the supervisor completed employee evaluation forming an employee completed employee evaluation. Then in step 620 the employee completed employee evaluation can be saved.

Additionally the method can include the step of: allowing an administrator to receive all real time scoring of all selected employees. The administrator can be a web server, an administrative server, or a person. If the administrator is a person, the person can view all the real time scoring of all selected employees with an executive dashboard, allowing company wide viewing of the scoring, as well as quick change and quick implementation of remediation or training for the selected employee(s).

The method can, in an embodiment, involve performing an exit interview of the selected employee and storing the exit interview in the database with the supervisor completed employee evaluation. The exit interview would include a review of all prior agreements, including secrecy agreements and obligations of non-complete; reviewing all agreed upon returns of employer data, employer equipment, and other materials for doing business; as well as reviewing information on health insurance, 401k, and other employee benefit plans.

The exit interview can be saved to the database.

The saving of the employee completed employee evaluation can include using computer instructions in the database to save the employee completed employee evaluation to the created employee profile in the database with all accompanying records and ratings.

While these embodiments have been described with emphasis on the embodiments, it should be understood that within the scope of the appended claims, the embodiments might be practiced other than as specifically described herein.

What is claimed:

1. A method for evaluating an employee for a supervisor, wherein the method for evaluating the employee comprises:
a. creating at least one department using at least one client device in communication with at least one processor, storing the at least one department in a database that is in communication with the at least one processor,
wherein the database comprises at least one fillable employee evaluation template with at least eight non-industry specific categories;
b. creating at least one employee profile using the at least one client device in communication with the at least one processor, storing the at least one employee profile in the database, associating the at least one employee profile with the at least one department;
c. creating at least one supervisor profile using the at least one client device in communication with the at least one processor, storing the at least one supervisor profile in the database, and associating the at least one supervisor profile with the at least one department;
d. performing an evaluation of a selected employee by the supervisor, wherein the evaluation comprises the steps of:
(i) selecting the at least one fillable employee evaluation template from the database;
(ii) selecting an employee profile associated with the selected employee;
(iii) clicking on 1 of 5 rating sections for each of the at least eight non-industry specific categories to designate a score for each of the at least eight non-industry specific categories;
(iv) viewing continually adjusting real time scoring for the selected employee;
(v) inserting supervisor comments into a supervisor comments section forming a supervisor completed employee evaluation; and
(vi) saving the supervisor completed employee evaluation.

2. The method of claim 1, further comprising:
a. providing the supervisor completed employee evaluation to the selected employee;
b. receiving employee comments;
c. inserting the employee comments into an employee comments section forming an employee completed employee evaluation; and
d. saving the employee completed employee evaluation.

3. The method of claim 1, further comprising printing the supervisor completed employee evaluation.

4. The method of claim 3, further comprising receiving the employee comments on the printed supervisor completed employee evaluation, and wherein the supervisor inputs the employee comments to the supervisor completed employee evaluation, forming an employee completed employee evaluation.

5. The method of claim 4, wherein the employee completed employee evaluation is printed.

6. The method of claim 5, further comprising the selected employee and the supervisor signing the employee completed employee evaluation.

7. The method of claim 1, wherein the continually adjusting real time scoring comprises a total score of the selected employee, an average score for all the at least eight non-industry specific categories, and a composite average score for all total scores of the selected employee.

8. The method of claim 7, wherein the composite average score is a score for up to twelve months of the total scores of the selected employee.

9. The method of claim 1, wherein each of the at least eight non-industry specific categories is a member of the group consisting of:
a. productivity;
b. teamwork;
c. job habits;
d. quality;
e. attendance;
f. flexibility;
g. dependability; and
h. job knowledge.

10. The method of claim 1, wherein the steps of creating the at least one department, creating the at least one employee profile, creating the at least one supervisor profile, and performing the evaluation of the selected employee are performed using computer instructions stored in the database.

11. The method of claim 10, further comprising creating an icon in a programs file of the at least one processor and on a desktop of the at least one client device to access the computer instructions stored in the database.

12. The method of claim 1, further comprising requiring a user ID and a password to access the computer instructions in the database.

13. The method of claim 1, further comprising allowing the selected employee to insert employee comments into the supervisor completed employee evaluation, before saving the supervisor completed employee evaluation.

14. The method of claim 1, wherein the at least eight non-industry specific categories are customizable by an authorized user.

15. The method of claim 14, further comprising the authorized user using computer instructions stored in the database to view a percentage of all employee profiles within each of the 1 of 5 rating sections in each of the at least eight non-industry specific categories.

16. The method of claim 2, further comprising the supervisor using computer instructions stored in the database to view a percentage of all employees associated with the supervisor in each of the at least eight non-industry specific categories.

17. The method of claim 1, wherein creating the at least one employee profile comprises uploading employee information from a linked data-source.

18. The method of claim 17, wherein the linked data-source is an excel file or a comma separated values file.

19. The method of claim 1, wherein creating the at least one employee profile comprises uploading a photo of the employee.

20. The method of claim 1, further comprising sending an e-mail notifying the selected employee that the supervisor completed employee evaluation has been completed.

21. The method of claim 1, further comprising the step of allowing an administrator to receive all continually adjusting real time scoring of all selected employees.

22. The method of claim 1, further comprising performing an exit interview of the selected employee and storing the exit interview in the database with the supervisor completed employee evaluation.
